(19) United States
(12) Patent Application Publication
(10) Pub. No.: US 2017/0004724 A1
(43) Pub. Date: Jan. 5, 2017

(54) COLLABORATIVE LEARNING SYSTEMS AND METHODS

(71) Applicant: Eyad FALLATAH, Revere, MA (US)

(72) Inventor: Eyad FALLATAH, Revere, MA (US)

(21) Appl. No.: 15/181,023

(22) Filed: Jun. 13, 2016

Related U.S. Application Data
(60) Provisional application No. 62/186,999, filed on Jun. 30, 2015.

(51) Int. Cl. G09B 7/04; H04L 12/58; G06F 3/0484; H04L 29/06; G06F 17/30

(52) U.S. Cl. CPC G09B 7/04; H04L 65/403; H04L 65/1069; G06F 17/30312; G06F 3/0484; H04L 51/046; G06F 17/30489

(57) ABSTRACT

A collaborative learning system includes processing circuitry configured to receive results from a preliminary test in a given subject matter for an individual; determine a response speed, a response length, and a response quality for each test problem of the received results from the preliminary test; receive a first draft solution to an assigned problem from the individual working alone; match the individual with another similar individual based upon the received results from the preliminary test and the determined response speed, the determined response length, and the determined response quality; receive a second draft solution to the assigned problem from the matched individuals working together; submit an instructor response to the assigned problem to the matched individuals working together; and receive individual results of a posttest in the given subject matter from the matched individuals.

### RELATED APPLICATION

This application claims priority to U.S. Provisional No. 62/186,999 filed on Jun. 30, 2015, which is incorporated in its entirety by reference herein.

### BACKGROUND

### Grant of Non-Exclusive Right

This application was prepared with financial support from the Saudi Arabian Cultural Mission, and in consideration therefore, the present inventor(s) has granted The Kingdom of Saudi Arabia a non-exclusive right to practice the present invention.

### Description of the Related Art

The “background” description provided herein is for the purpose of generally presenting the context of the disclosure. Work of the presently named inventors, to the extent it is described in this background section, as well as aspects of the description which may not otherwise qualify as conventional art at the time of filing, are neither expressly nor impliedly admitted as conventional art against the present disclosure.

A learning environment can include many different types of environments, processes, and tools. In addition, a learning environment can include individual learners, paired or groups of learners, and one or more learners combined with an instructor or expert within the subject matter field.

An individual working environment holds an individual entirely responsible for the research, preparation, and completion of an assignment. This environment holds the individual directly responsible for the assignment. The individual is directly evaluated and judged, based on the completed assignment. In addition, there are few physical constraints on the learning environment for a single individual. However, the finished assignment may be lacking in content, quality, and/or production expectations as a result of the limited knowledge and efficiencies of the individual. In addition, there is no feedback provided to the individual.

In a matched or group environment, the research, preparation, and completion of an assignment is shared between the group members. This environment allows a pair or group to brain storm ideas and possible solutions. This allows the pair or group to build more positive and constructive ideas as a combined whole. As a result, the finished assignment is likely to be of higher quality and value than the same assignment completed by each member individually. However, the contribution of each member in a group environment may not be equally shared, where some members may do most of the work and other members may do very little work. In addition, it is difficult to evaluate each member, since the individual contributions are not clear.

In a shared environment, the research, preparation, and completion of an assignment by an individual or by a group is compared to an assignment completed by an instructor or expert within the subject matter area. The shared environment provides a mechanism for the individual or group members to check the accuracy of tasks completed or problems solved, and also to check the final form or readiness of the completed task or assignment. One disadvantage of a shared environment is one or more members may not properly prepare the assignment in the individual phase and/or the paired/group phase because he/she knows the “correct answer” will be revealed later in the process, and any necessary corrections can be made at that time. In addition, a large amount of time of adequately-prepared individuals might be wasted during the evaluation and instruction of a poorly-prepared individual.

A collective learning environment can include an individual phase combined with a group phase, an individual phase combined with a shared phase, or all three phases of an individual phase, a paired/group phase, and a shared phase combined. However, there can be one or more physical limitations in implementing the paired/group phase and the shared phase. For example, members of the group may need to be physically located in the same room or area to converse or to use shared materials. There is also a likelihood of being grouped with many of the same members in the paired/group phase for subsequent assignments. In addition, there is no mechanism to evaluate the effectiveness of a single phase or a group of phases.

### SUMMARY

In one embodiment, a method of collaborative learning includes receiving via a graphical user interface (GUI), results from a preliminary test in a given subject matter for an individual, and saving via a database, the results of the preliminary test. The method also includes determining via a processor, a response speed, a response length, and a response quality for each test problem of the received results from the preliminary test, and saving via the database, the determined response speed, the determined response length, and the determined response quality. The method also includes receiving via the GUI, a first draft solution to an assigned problem from the individual working alone, and matching via the processor, the individual with another similar individual based upon the received results from the preliminary test and the determined response speed, the determined response length, and the determined response quality. The method also includes receiving via the GUI, a second draft solution to the assigned problem from the matched individuals working together, and submitting via the GUI, an instructor response to the assigned problem to the matched individuals working together. The method also includes receiving via the GUI, individual results of a posttest in the given subject matter from the matched individuals, and saving via the database, the individual results of the posttest for the matched individuals.

In another embodiment, a collaborative learning system includes processing circuitry. The processing circuitry is configured to receive results from a preliminary test in a given subject matter for an individual, and save the results of the preliminary test. The processing circuitry is also configured to determine a response speed, a response length, and a response quality for each test problem of the received results from the preliminary test, and save the determined response speed, the determined response length, and the determined response quality. The processing circuitry is also configured to receive a first draft solution to an assigned problem from the individual working alone, and match the individual with another similar individual based upon the received results from the preliminary test and the determined response speed, the determined response length, and the determined response quality. The processing circuitry is also configured to receive a second draft solution to the assigned problem from the matched individuals working together, and submit an instructor response to the assigned problem to the matched individuals working together. The processing circuitry is also configured to receive individual results of a posttest in the given subject matter from the matched individuals, and save the individual results of the posttest for the matched individuals.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exemplary collaborative learning system according to one embodiment;

FIG. 2 illustrates different factors used to determine a match of a user with another user according to one embodiment;

FIGS. 3A-3C is an exemplary algorithm used to match a user with a similar user according to one embodiment;

FIG. 4 illustrates an exemplary collaborative learning system according to one embodiment;

FIG. 5 is a block diagram illustrating an exemplary electronic device according to one embodiment;

FIG. 6 is a block diagram illustrating a hardware description of a computing device according to one embodiment;

FIG. 7 is a block diagram illustrating a data processing system according to one embodiment; and

FIG. 8 is a block diagram illustrating an implementation of a CPU according to one embodiment.

### DETAILED DESCRIPTION

Systems, methods, and computer-readable media for electronic collaborative learning are described herein. Stages of individual, small group, and large group learning sessions utilize computer-implemented features of pretesting and posttesting before and after the collaborative learning, respectively. A history of each participant's learning skills and previous session partners are archived. A participant is matched with a similar-skilled participant.

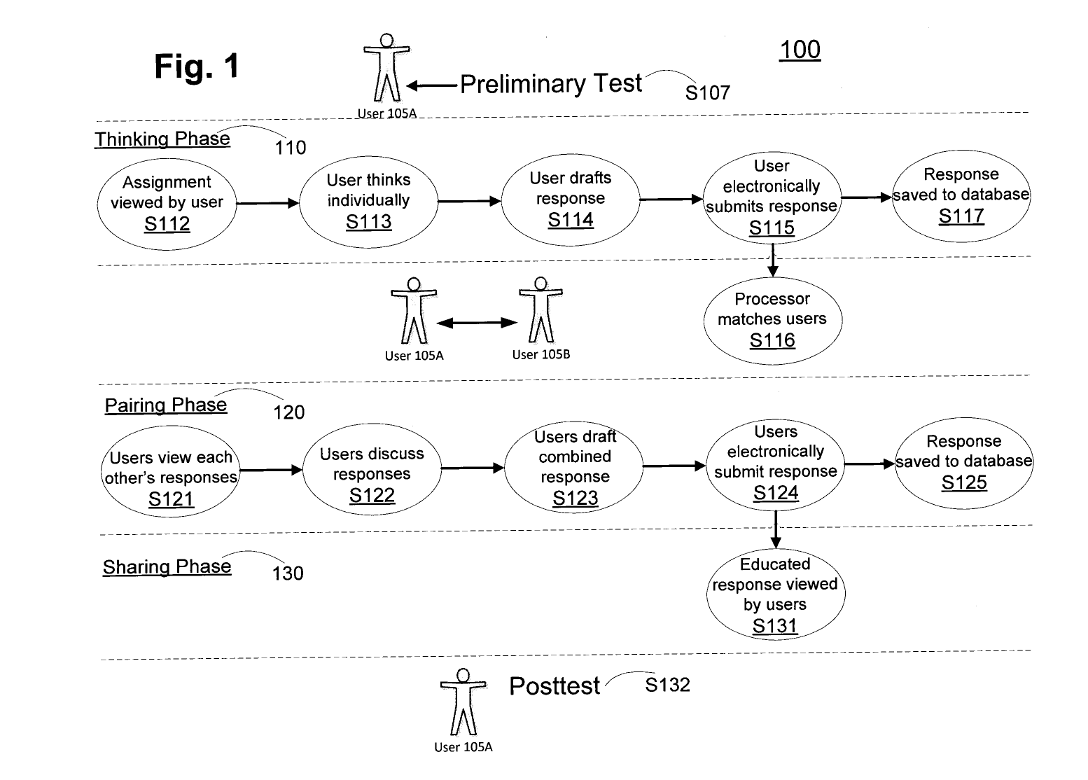

An exemplary collaborative learning system 100 is illustrated in FIG. 1, which includes a thinking phase 110, a pairing phase 120, and a sharing phase 130. In step S107, a preliminary test in a given subject matter is administered to a user 105A.

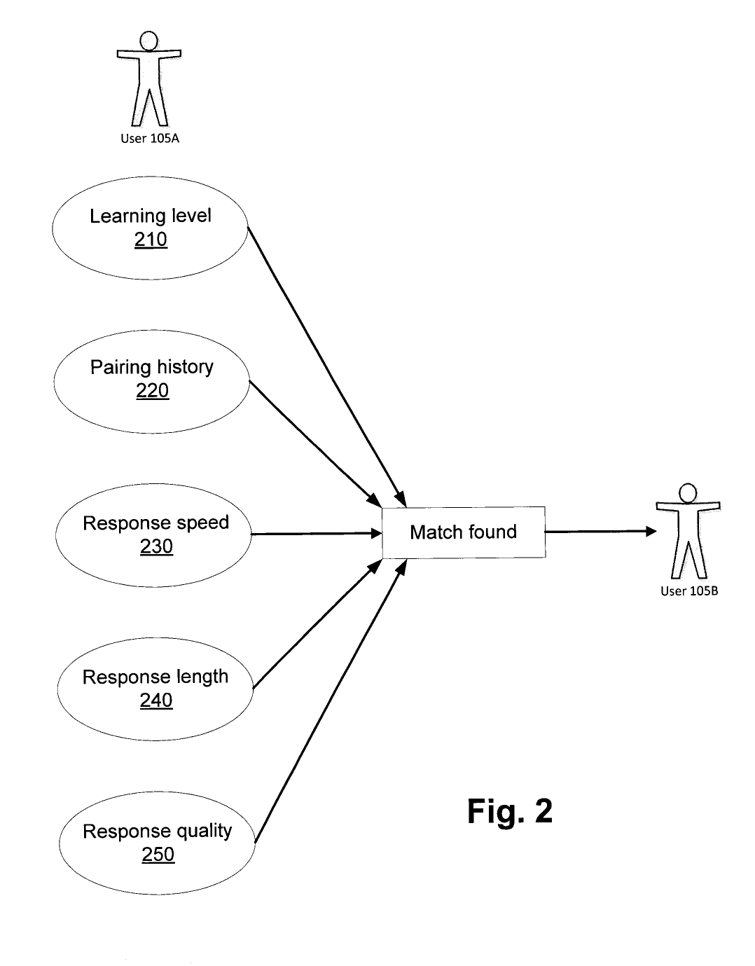

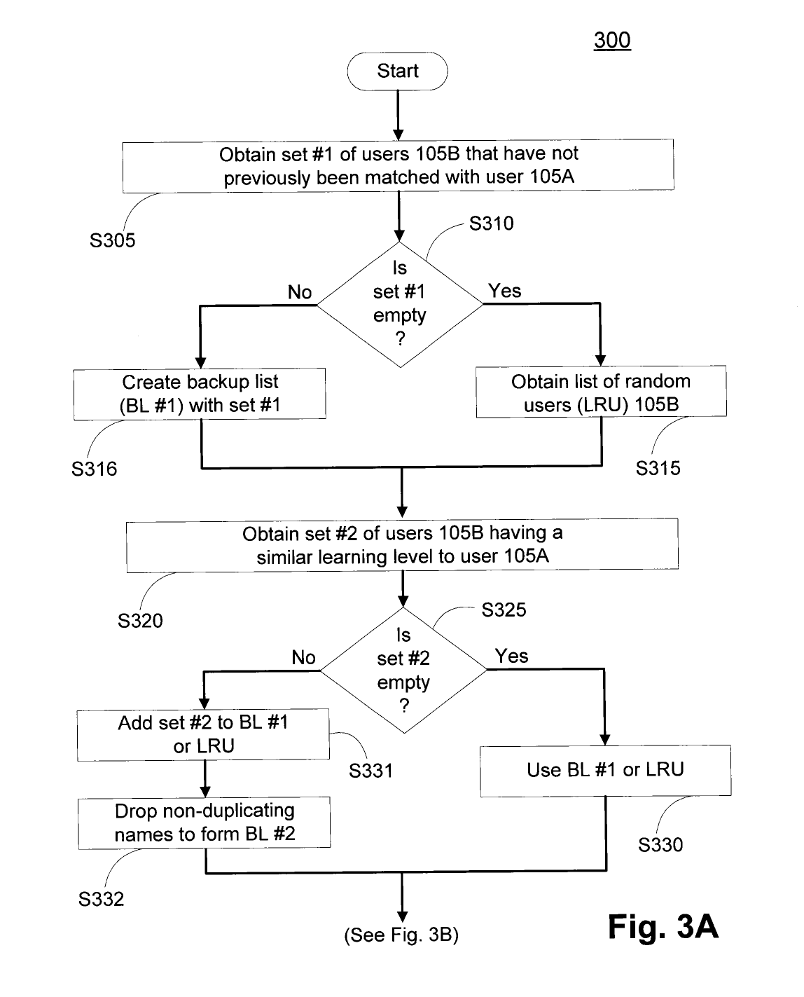

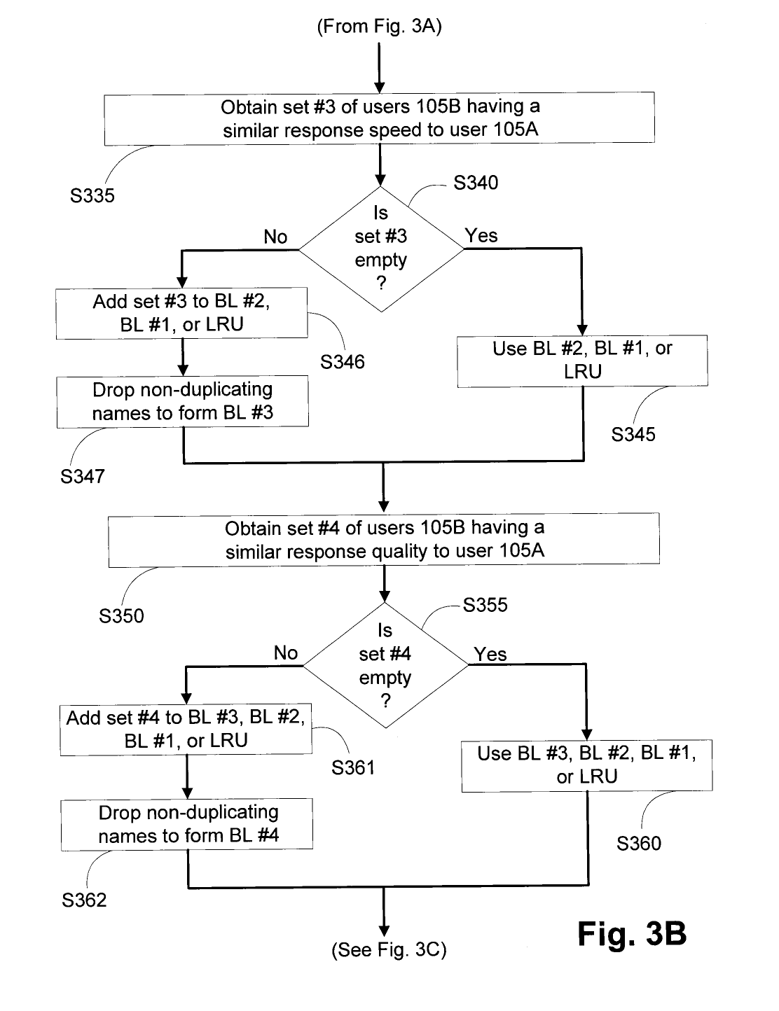

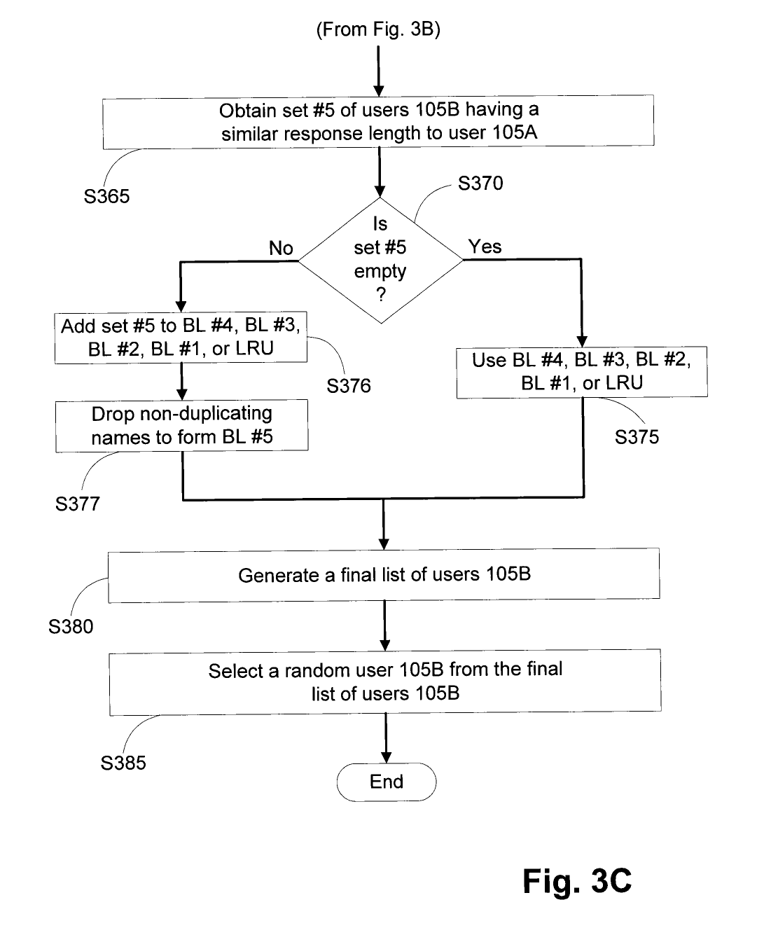

In the thinking phase 110 at step S 112, an assignment having one or more questions in the given subject matter area is viewed by the user 105A. In step S113, the user 105A thinks, analyzes, and researches each question for a possible solution on an individual basis. In step S114, the user 105A drafts a response to each question, based upon his/her individual thinking, analyzing, and research from step S113. In step S115, the user 105A electronically submits his/her response. In step S116, a collaborative learning processor matches user 105A to another user 105B, based on a determined learning level of user 105A. Matching user 105A to another user 105B is described in more detail herein with reference to FIGS. 2 and 3A-3C. In step S117, the submitted response is saved to a database.

In the pairing phase 120 at step S121, user 105A and his/her paired user 105B view each other's information and submitted responses. In step S122, user 105A and his/her paired user 105B conduct a chat session to discuss their respective information and responses. In step S123, user 105A and his/her paired user 105B draft a combined response to the assignment. In step S124, the combined response is electronically submitted. In step S125, the combined response is saved to the database.

In the sharing phase 130 at step S131, an educated response to the given assignment is viewed by the user 105A and his/her paired user 105B. An educated response includes a response prepared by an instructor or other expert in the given subject matter field.

In step S132, a posttest is given to the user 105A. The posttest is the same as the preliminary test for the given subject matter. In an alternative embodiment, other questions can be included in the posttest, in addition to the original questions from the preliminary test.

The preliminary test results are compared to the posttest results to determine various factors used to match two or more users 105A and 105B together in a collaborative learning session. Factors include, but are not limited to, a time of completion for an individual response for the assignment, a length of individual response for the assignment, and a quality score of an individual response for the assignment. All times of completion, all lengths of individual responses, and all quality scores of individual responses may be averaged. Results for the factors are saved to the database. Factors are described in more detail herein with reference to FIG. 2.

FIG. 2 illustrates different factors used to determine a match of user 105A with another user 105B in a collaborative learning session. FIG. 2 illustrates user 105A being matched with just one other user 105B. However, there may be collaborative learning sessions in which it is desirable to match more than two users together, such as for the completion of a project.

A learning level 210 is used to determine a match of user 105A to another user 105B in the collaborative learning session. Since each user 105 is given a preliminary test and a posttest, scores can be obtained to reflect a performance of the user 105A, how fast the user 105A learns, and how much the user 105A knows about the subject that is being taught. The learning system 100 matches two or more users 105 together to make certain the users 105 are paired with someone at or near the same learning level.

A pairing history 220 is also used to determine a match of user 105A to another user 105B in the collaborative learning session. A history of paired users 105 is kept to avoid pairing the same users 105 together frequently. The learning system 100 attempts to match user 105A with a new user 105B within the same learning level each time. By pairing users 105 together electronically, each user 105A is much more likely to be paired with a different user 105B for each learning session, as compared to a physical pairing of two or more users 105. The pool of electronic users 105 within the same learning level could be on the order of thousands of users 105. Electronically-paired users 105 also have the benefit of anonymity, wherein differences of age, sex, physical appearance, and personality have little or no influence on the collaborative learning session.

In contrast, a physical learning environment having a thinking phase, a pairing phase, and a sharing phase is limited by the physical confines of the room. This greatly increases the probability of a user being paired with a previously-paired user, especially for a small physical learning environment. In addition, the paired users need to be in close vicinity to each other.

A response speed 230 is also used to determine a match of user 105A to another user 105B in the collaborative learning session. Each time user 105A submits a response individually during the thinking phase 110, the learning system 100 calculates the time spent from start to finish for each question of the assignment. The result is saved in the database. All records of time spent during the thinking phase 110 for all users 105 may be averaged to calculate the speed of a typical user in response to an assignment. The resulting data is used for matching to make certain user 105A is matched with another user 105B of similar speed.

A response length 240 is also used to determine a match of user 105A to another user 105B in the collaborative learning session Each time user 105A submits a response individually during the thinking phase 110, the learning system 100 calculates the length of the response to each question, such as the total number of characters used, which is saved to the database. However, other measures can be used to calculate a length of a response to a question. All records of response lengths for all users 105 may be averaged to calculate the length of a typical user's response. The resulting data is used during the matching to match user 105A with another user 105B that has similar response lengths.

A response quality 250 is also used to determine a match of user 105A to another user 105B in the collaborative learning session. Each time user 105A submits an individual response during the thinking phase 110, the learning system 100 checks the response quality and assigns a quality score. A measure of quality, such as a scale of 1-100, can be assigned based on factors, such as grammatical errors, misspellings, styling errors, and syntax errors (for programming code).

FIGS. 3A-3C illustrate an exemplary algorithm 300 used to match user 105A with a similar user 105B. In FIG. 3A at step S305, a set #1 of users 105B that have not previously worked with user 105A is obtained. In step S310, it is determined whether set #1 is empty. If set #1 is empty (YES in step S310), a list of random users (LRU) 105B is obtained in step S315. If set #1 is not empty (NO in step S310), a backup list, BL #1 is created from set #1 in step S316.

In step S320, a set #2 of users 105B having a similar learning level to user 105A is obtained. In step S325, it is determined whether set #2 is empty. If set #2 is empty (YES in step S325), either BL #1 or the LRU is used in step S330. For example, BL #1 is used in step S330 when set #1 was not empty (NO in step S310). The LRU is used in step S330 when set #1 was empty (YES in step S310).

If set #2 is not empty (NO in step S325), set #2 is added to either BL #1 or the LRU in step S331. For example, set #2 is added to BL #1 in step S331 when set #1 was not empty (NO in step S310). Set #2 is added to the LRU in step S331 when set #1 was empty (YES in step S310). In step S332, non-duplicating names from BL #1 or the LRU are dropped to form BL #2.

In FIG. 3B at step S335, a set #3 of users 105B having a similar response speed to user 105A is obtained. In step S340, it is determined whether set #3 is empty. If set #3 is empty (YES in step S340), BL #2, BL #1, or the LRU is used in step S345. In step S345, the list to be used is determined by whichever list was handed down from previous steps. For example, BL #2 is used in step S345 when set #2 was not empty (NO in step S325). BL #1 is used in step S345 when set #1 was not empty (NO in step S310). BL #1 is used in step S345 regardless of the decision made in step S325. The LRU is used in step S345 when set #1 was empty (YES in step S310). The LRU is used in step S345 regardless of the decision made in step S325.

If set #3 is not empty (NO in step S340), set #3 is added to BL #2, BL #1, or the LRU in step S346. In step S346, set #3 is added to whichever list was handed down from previous steps. For example, set #3 is added to BL #2 in step S346 when set #2 was not empty (NO in step S325). Set #3 is added to BL #1 in step S346 when set #1 was not empty (NO in step S310). Set #3 is added to BL #1 in step S346 regardless of the decision made in step S325. Set #3 is added to the LRU in step S346 when set #1 was empty (YES in step S310). Set #3 is added to the LRU in step S346 regardless of the decision made in step S325. In step S347, non-duplicating names from BL #2, BL #1, or the LRU are dropped to form BL #3.

In step S350, a set #4 of users 105B having a similar response quality to user 105A is obtained. In step S355, it is determined whether set #4 is empty. If set #4 is empty (YES in step S355), BL #3, BL #2, BL #1, or the LRU is used in step S360. In step S360, the list to be used is determined by whichever list was handed down from previous steps. For example, BL #3 is used in step S360 when set #3 was not empty (NO in step S340). BL #2 is used in step S360 when set #2 was not empty (NO in step S325). BL #2 is used in step S360 regardless of the decision made in step S340. BL #1 is used in step S360 when set #1 was not empty (NO in step S310). BL #1 is used in step S360 regardless of the decisions made in steps S340 and S325. The LRU is used in step S360 when set #1 was empty (YES in step S310). The LRU is used in step S360 regardless of the decisions made in steps S340 and S325.

If set #4 is not empty (NO in step S355), set #4 is added to BL #3, BL #2, BL #1, or the LRU in step S361. In step S361, set #4 is added to whichever list was handed down from previous steps. For example, set #4 is added to BL #3 in step S361 when set #3 is not empty (NO in step S340). Set #4 is added to BL #2 in step S361 when set #2 was not empty (NO in step S325). Set #4 is added to BL #2 in step S361 regardless of the decision made in step S340. Set #4 is added to BL #1 in step S361 when set #1 was not empty (NO in step S310). Set #4 is added to BL #1 in step S361 regardless of the decisions made in steps S340 and S325. Set #4 is added to the LRU in step S361 when set #1 was empty (YES in step S310). Set #4 is added to the LRU in step S361 regardless of the decisions made in steps S340 and S325. In step S362, non-duplicating names from BL #3, BL #2, BL #1, or the LRU are dropped to form BL #4.

In FIG. 3C at step S365, a set #5 of users 105B having a similar response length to user 105A is obtained. In step S370, it is determined whether set #5 is empty. If set #5 is empty (YES in step S370), BL #4, BL #3, BL #2, BL #1, or the LRU is used in step S375. In step S375, the list to be used is determined by whichever list was handed down from previous steps. For example, BL #4 is used in step S375 when set #4 was not empty (NO in step S355). BL #3 is used in step S375 when set #3 is not empty (NO in step S340). BL #3 is used in step S375 regardless of the decision made in step S355. BL #2 is used in step S375 when set #2 was not empty (NO in step S325). BL #2 is used in step S375 regardless of the decisions made in steps S355 and S340. BL #1 is used in step S375 when set #1 was not empty (NO in step S310). BL #1 is used in step S375 regardless of the decisions made in steps S355, S340, and S325. The LRU is used in step S375 when set #1 was empty (YES in step S310). The LRU is used in step S375 regardless of the decisions made in steps S355, S340, and S325. In step S377, non-duplicating names from BL #4, BL #3, BL #2, BL #1, or the LRU are dropped to form BL #5.

If set #5 is not empty (NO at step S370), set #5 is added to BL #4, BL #3, BL #2, BL #1, or the LRU in step S376. In step S376, set #5 is added to whichever list was handed down from previous steps. For example, set #5 is added to BL #4 when set #4 was not empty (NO in step S355). Set #5 is added to BL #3 when set #3 was not empty (NO in step S340). Set #5 is added to BL #3 in step S376 regardless of the decision made in step S355. Set #5 is added to BL #2 in step S376 when set #2 was not empty (NO in step S325). Set #5 is added to BL #2 in step S376 regardless of the decisions made in steps S355 and S340. Set #5 is added to BL #1 in step S376 when set #1 was not empty (NO in step S310). Set #5 is added to BL #1 in step S376 regardless of the decisions made in steps S355, S340, and S325. Set #5 is added to the LRU in step S376 when set #1 was empty (YES in step S310). Set #5 is added to the LRU in step S376 regardless of the decisions made in steps S355, S340, and S325.

In step S380, a final list of users 105B is generated. The final list includes users 105B that have not previously worked with the user 105A and have a similar learning level, a similar response speed, a similar response quality, and a similar response length to the user 105A. The final list includes the contents of BL #5 after the duplicating names have been dropped. In step S385, a random user 105B is selected from the final list of users 105B to be matched with user 105A.

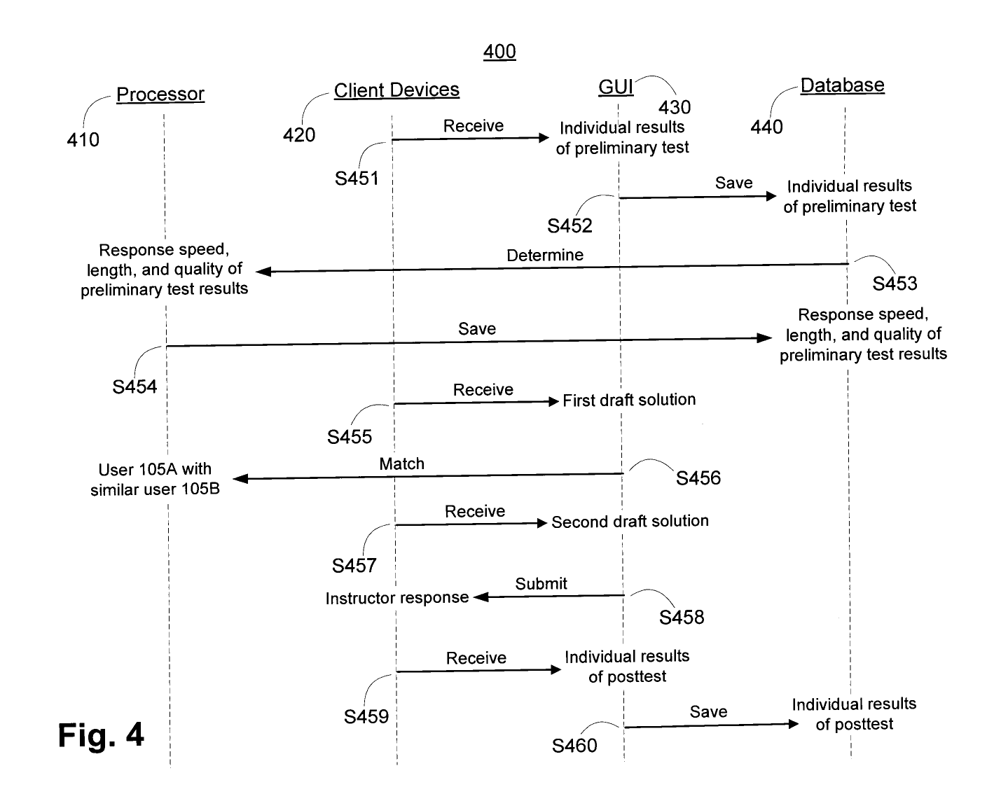

FIG. 4 illustrates an exemplary collaborative learning system 400 for embodiments described herein. In step S451, individual results of preliminary tests are received at a Graphical User Interface (GUI) 430 from one or more client devices 420. In step S452, the individual results of preliminary tests are saved in a database 440. In step S453, the response speed, length of response, and quality of response for each individual from the preliminary test results are determined at a processor 410. In step S454, the response speed, length, and quality of preliminary test results for each individual are saved in the database 440.

In step S455, a first draft of a solution from each individual is received at the GUI 430 from respective client devices 420. In step S456, user 105A is matched with another user 105B of similar skill level at the processor 410. In step S457, a second draft solution is received from each pair of individual client devices 420 working together at the GUI 430. In step S458, an instructor response is submitted to each pair of individuals at the respective client devices 420. In step S459, results of a completed posttest for each individual client device 420 are received at the GUI 430. In step S460, the results of the individual posttests are saved at the database 440.

The content of the preliminary test is included in the content of the posttest. In an alternative embodiment, other questions can be included in the posttest, in addition to the original questions from the preliminary test.

A description is given to illustrate one embodiment using the disclosures described herein. However, this is given for illustrative purposes only, and other examples using the disclosures are contemplated by embodiments described herein.

An exemplary collaborative system includes a GUI and a display, which displays existing classes for a registered and logged-in user. Information about each class can be viewed, along with any assignments or exercises associated with the class(es). A calendar can be accessed, which displays the due dates for assignments.

In one example an assignment can be completed by two users 105A and 105B in a think-pair-share activity, as described above with reference to the algorithm of FIGS. 3A-3C and the collaborative learning system of FIG. 4. In an alternative embodiment, the posttest can be administered after the thinking phase or the pairing phase, instead of after the sharing phase.

During the thinking phase, the GUI displays one or more problems for the user 105A to individually solve. The GUI provides an area in which to input a solution. A timer is also displayed, which records the time expended for each problem.

During the pairing phase, user 105A and paired user 105B discuss their respective answers with one another in a chat-like session. A comment box is also available for each user 105A and 105B to input their respective comments. These comments are only available to the authored user 105 and are not accessible to the other user 105, unless the authored user 105 makes the comments visible.

During the sharing phase, the instructor's solution is displayed to the users 105A and 105B. The instructor can guide the entire class through a group-based discussion in order to highlight good practices used to arrive at a correct solution. In one example, answers for the instructor, user 105A and/or user 105B can be hidden or displayed for other parties to view.

The posttest is administered at the end of the interactive session, or it can be administered after the thinking phase or the pairing phase. The administration of the posttest can be governed by the instructor. In one example, a user 105A or 105B can return back to an activity or return to a main view to select a different option, before completing the posttest. The posttest is the same as the preliminary test. In an alternative embodiment, other questions can be included in the posttest, in addition to the original questions from the preliminary test.

Another example includes a think-share activity, which is completed individually. The user 105A completes a preliminary test of multiple questions in a particular chosen field. The user 105A attempts to find a solution to each problem individually. An instructor or other educated person in the chosen field leads the class exercise of users 105A and 105B that worked individually. During a sharing phase, the instructor discusses one or more optimal solutions to the exercise problems. A posttest is given to each user 105A and 105B to complete individually. The posttest is the same as the preliminary test. In an alternative embodiment, other questions can be included in the posttest, in addition to the original questions from the preliminary test.

The processors, client devices, GUIs, and databases described herein are used to execute steps within the collaborative learning system and collaborative learning algorithm. The resulting processing circuitry, programming, and hardware are incorporated into a special purpose computing device, by which the functions are executed and the advantages of embodiments described herein are achieved.

One advantage of the collaborative learning system is users 105A and 105B can return to the interactive electronic platform to review and practice solving problems. This can be useful prior to an examination. The interactive electronic platform provides a virtual tutorial for the users 105A and 105B.

Another advantage of the collaborative learning system includes introducing multiple approaches and views to the same problem. This is achieved by reviewing the solutions of other users 105B, as well as the instructor's solution(s).

Another advantage of the collaborative learning system includes repetition in problem solving. This provides the advantage of engraining frequently-used paths to achieve an efficient solution. In one example, this can enable users 105A and 105B to write more concise code in the field of programming.

A physical learning environment is limited by the physical confines of the room. This greatly increases the probability of user 105A being paired with a previously-paired user 105B, especially for a small physical learning environment. In addition, the paired users 105 need to be in close vicinity to each other. In contrast, embodiments described herein match users 105 together electronically, via a chat session. As a result, each user 105A is much more likely to be paired with a different user 105B for each learning session. The pool of electronic users 105 within the same learning level could be on the order of thousands of users 105. Electronically-paired users 105 also have the benefit of anonymity, wherein differences of age, sex, physical appearance, and personality have little or no influence on the collaborative learning session.

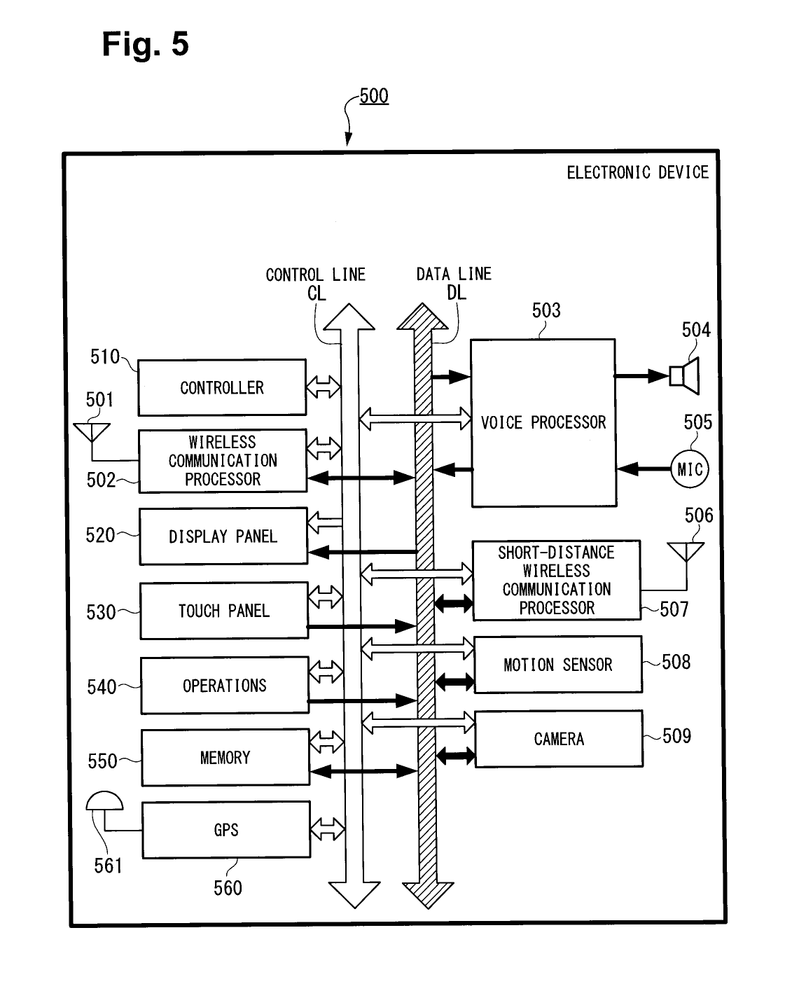

FIG. 5 is a block diagram illustrating an exemplary electronic device 500 used in accordance with embodiments of the present disclosure. In some embodiments, electronic device 500 can be a smartphone, a laptop, a tablet, a server, an e-reader, a camera, a navigation device, etc. Electronic device 500 can be used as one or more of the client devices 420 and the GUI 430 illustrated in FIG. 4.

The exemplary electronic device 500 of FIG. 5 includes a controller 510 and a wireless communication processor 502 connected to an antenna 501. A speaker 504 and a microphone 505 are connected to a voice processor 503.

The controller 510 can include one or more CPUs, and can control each element in the electronic device 500 to perform functions related to communication control, audio signal processing, control for the audio signal processing, still and moving image processing and control, and other kinds of signal processing. The controller 510 can perform these functions by executing instructions stored in a memory 550. Alternatively or in addition to the local storage of the memory 550, the functions can be executed using instructions stored on an external device accessed on a network or on a non-transitory computer readable medium.

The memory 550 includes, but is not limited to, Read Only Memory (ROM), Random Access Memory (RAM), or a memory array including a combination of volatile and non-volatile memory units. The memory 550 can be utilized as working memory by the controller 510 while executing the processes and algorithms of the present disclosure. Additionally, the memory 550 can be used for long-term storage, e.g., storage of image data and information related thereto.

The electronic device 500 includes a control line CL and data line DL as internal communication bus lines. Control data to/from the controller 510 can be transmitted through the control line CL. The data line DL can be used for transmission of voice data, display data, etc.

The antenna 501 transmits/receives electromagnetic wave signals between base stations for performing radio-based communication, such as the various forms of cellular telephone communication. The wireless communication processor 502 controls the communication performed between the electronic device 500 and other external devices, via the antenna 501. For example, the wireless communication processor 502 can control communication between base stations for cellular phone communication.

The speaker 504 emits an audio signal corresponding to audio data, supplied from the voice processor 503. The microphone 505 detects surrounding audio and converts the detected audio into an audio signal. The audio signal can be output to the voice processor 503 for further processing. The voice processor 503 demodulates and/or decodes the audio data read from the memory 550 or audio data received by the wireless communication processor 502 and/or a short-distance wireless communication processor 507. Additionally, the voice processor 503 can decode audio signals obtained by the microphone 505.

The exemplary electronic device 500 can also include a display panel 520, a touch panel 530, an operations key 540, and the short-distance communication processor 507 connected to an antenna 506. The display panel 520 can be a Liquid Crystal Display (LCD), an organic electroluminescence display panel, or another display screen technology. In addition to displaying still and moving image data, the display panel 520 can display operational inputs, such as numbers or icons which can be used for control of the electronic device 500. The display panel 520 can additionally display a GUI for a user to control aspects of the electronic device 500 and/or other devices. Further, the display panel 520 can display characters and images received by the electronic device 500 and/or stored in the memory 550 or accessed from an external device on a network. For example, the electronic device 500 can access a network, such as the Internet and display text and/or images transmitted from a Web server.

The touch panel 530 can include a physical touch panel display screen and a touch panel driver. The touch panel 530 can include one or more touch sensors for detecting an input operation on an operation surface of the touch panel display screen. The touch panel 530 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus, such that the sensors included in the touch panel 530 can detect when the stylus approaches/contacts the operation surface of the touch panel display (similar to the case in which a finger is used for the touch operation).

According to aspects of the present disclosure, the touch panel 530 can be disposed adjacent to the display panel 520 (e.g., laminated) or can be formed integrally with the display panel 520. For simplicity, the present disclosure assumes the touch panel 530 is formed integrally with the display panel 520 and therefore, examples discussed herein can describe touch operations being performed on the surface of the display panel 520, rather than the touch panel 530. However, the skilled artisan will appreciate that this is not limiting.

For simplicity, the present disclosure assumes the touch panel 530 is a capacitance-type touch panel technology. However, it should be appreciated that aspects of the present disclosure can easily be applied to other touch panel types (e.g., resistance-type touch panels) with alternate structures. According to aspects of the present disclosure, the touch panel 530 can include transparent electrode touch sensors arranged in the X-Y direction on the surface of transparent sensor glass.

The touch panel driver can be included in the touch panel 530 for control processing related to the touch panel 530, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen.

Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 530 and the display panel 520 can be surrounded by a protective casing, which can also enclose the other elements included in the electronic device 500. According to aspects of the disclosure, a position of the user's fingers on the protective casing (but not directly on the surface of the display panel 520) can be detected by the touch panel 530 sensors. Accordingly, the controller 510 can perform display control processing described herein based on the detected position of the user's fingers gripping the casing. For example, an element in an interface can be moved to a new location within the interface (e.g., closer to one or more of the fingers) based on the detected finger position.

Further, according to aspects of the disclosure, the controller 510 can be configured to detect which hand is holding the electronic device 500, based on the detected finger position. For example, the touch panel 530 sensors can detect a plurality of fingers on the left side of the electronic device 500 (e.g., on an edge of the display panel 520 or on the protective casing), and detect a single finger on the right side of the electronic device 500. In this exemplary scenario, the controller 510 can determine that the user is holding the electronic device 500 with his/her right hand because the detected grip pattern corresponds to an expected pattern when the electronic device 500 is held only with the right hand.

The operation key 540 can include one or more buttons or similar external control elements, which can generate an operation signal based on a detected input by the user. In addition to outputs from the touch panel 530, these operation signals can be supplied to the controller 510 for performing related processing and control. According to aspects of the disclosure, the processing and/or functions associated with external buttons and the like can be performed by the controller 510 in response to an input operation on the touch panel 530, rather than the external button, key, etc. In this way, external buttons on the electronic device 500 can be eliminated in lieu of performing inputs, via touch operations, thereby improving water-tightness.

The antenna 506 can transmit/receive electromagnetic wave signals to/from other external apparatuses, and the short-distance wireless communication processor 507 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 507.

The electronic device 500 can include a motion sensor 508. The motion sensor 508 can detect features of motion (i.e., one or more movements) of the electronic device 500. For example, the motion sensor 508 can include an accelerometer to detect acceleration, a gyroscope to detect angular velocity, a geomagnetic sensor to detect direction, a geo-location sensor to detect location, etc., or a combination thereof to detect motion of the electronic device 500.

According to aspects of the disclosure, the motion sensor 508 can generate a detection signal that includes data representing the detected motion. For example, the motion sensor 508 can determine a number of distinct movements in a motion (e.g., from start of the series of movements to the stop, within a predetermined time interval, etc.), a number of physical shocks on the electronic device 500 (e.g., a jarring, hitting, etc., of the electronic device 500), a speed and/or acceleration of the motion (instantaneous and/or temporal), or other motion features. The detected motion features can be included in the generated detection signal. The detection signal can be transmitted, e.g., to the controller 510, whereby further processing can be performed based on data included in the detection signal.

The motion sensor 508 can work in conjunction with a Global Positioning System (GPS) 560. The GPS 560 detects the present position of the electronic device 500. The information of the present position detected by the GPS 560 is transmitted to the controller 510. An antenna 561 is connected to the GPS 560 for receiving and transmitting signals to and from a GPS satellite.

Electronic device 500 can include a camera 509, which includes a lens and a shutter for capturing photographs of the surroundings around the electronic device 500. In an embodiment, the camera 509 captures surroundings of an opposite side of the electronic device 500 from the user. The images of the captured photographs can be displayed on the display panel 520. A memory saves the captured photographs. The memory can reside within the camera 509 or it can be part of the memory 550. The camera 509 can be a separate feature attached to the electronic device 500 or it can be a built-in camera feature.

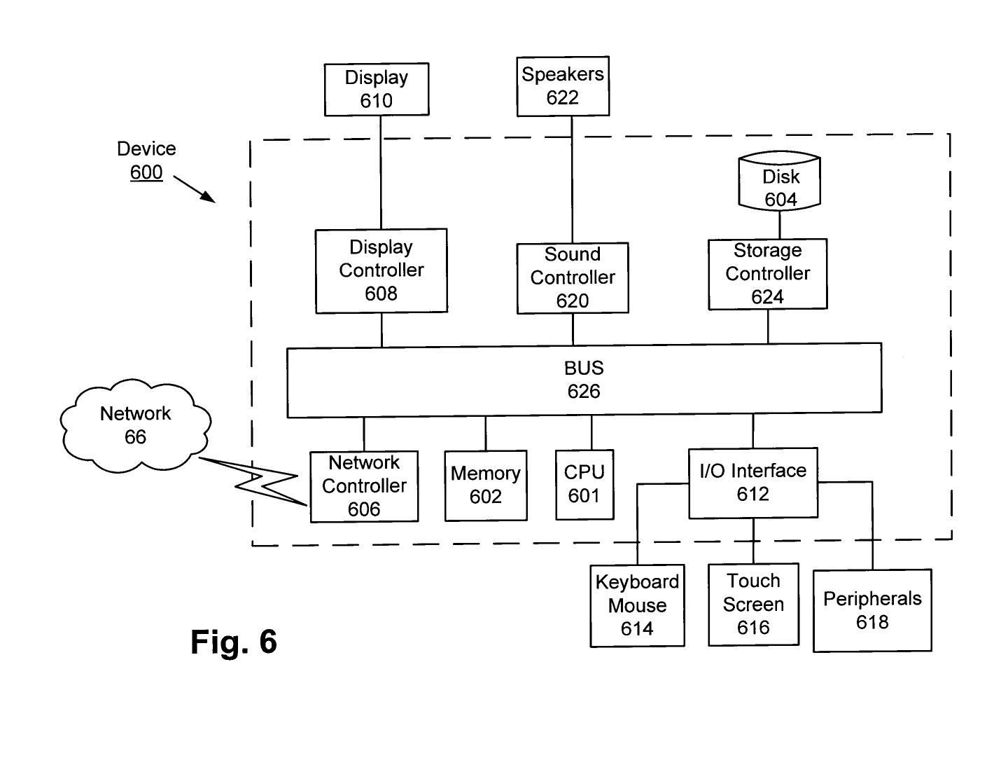

FIG. 6 is a block diagram of a hardware description of a computing device 600, used in accordance with exemplary embodiments. One or more features described above with reference to electronic device 500 of FIG. 5 can be included in computing device 600 described herein. Computing device 600 could be used as one or more of the devices illustrated in processor 410 and database 440 in FIG. 4.

In FIG. 6, the computing device 600 includes a CPU 601 which performs the processes described herein. The process data and instructions can be stored in memory 602. These processes and instructions can also be stored on a storage medium disk 604, such as a hard disk drive (HDD) or portable storage medium, or they can be stored remotely. Further, the claimed embodiments are not limited by the form of the computer-readable media on which the instructions of the embodied process are stored. For example, the instructions can be stored on CDs, DVDs, in FLASH memory, RAM, ROM, PROM, EPROM, EEPROM, hard disk or any other information processing device with which the computing device 600 communicates, such as a server or computer.

Further, the claimed embodiments can be provided as a utility application, background daemon, or component of an operating system, or combination thereof, executing in conjunction with CPU 601 and an operating system such as Microsoft Windows 7, UNIX, Solaris, LINUX, Apple MAC-OS and other systems known to those skilled in the art.

CPU 601 can be a Xenon or Core processor from Intel of America or an Opteron processor from AMD of America, or it can be other processor types that would be recognized by one of ordinary skill in the art. Alternatively, the CPU 601 can be implemented on an FPGA, ASIC, PLD or using discrete logic circuits, as one of ordinary skill in the art would recognize. Further, CPU 601 can be implemented as multiple processors cooperatively working in parallel to perform the instructions of the inventive processes described above.

The computing device 600 in FIG. 6 also includes a network controller 606, such as an Intel Ethernet PRO network interface card from Intel Corporation of America, for interfacing with network 66. As can be appreciated, the network 66 can be a public network, such as the Internet, or a private network such as an LAN or WAN network, or any combination thereof and can also include PSTN or ISDN sub-networks. The network 66 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 600 further includes a display controller 608, such as a NVIDIA GeForce GTX or Quadro graphics adaptor from NVIDIA Corporation of America for interfacing with display 610, such as a Hewlett Packard HPL2445w LCD monitor. An I/O interface 612 interfaces with a keyboard and/or mouse 614, as well as a touch screen 616 on or separate from display 610. I/O interface 612 also connects to a variety of peripherals 618 including printers and scanners, such as an OfficeJet or DeskJet from Hewlett Packard.

A sound controller 620 is also provided in the computing device 600, such as Sound Blaster X-Fi Titanium from Creative, to interface with speakers/microphone 622, thereby providing sounds and/or music.

The storage controller 624 connects the storage medium disk 604 with communication bus 626, which may be an ISA, EISA, VESA, PCI, or similar, for interconnecting all of the components of the computing device 600. A description of the general features and functionality of the display 610, keyboard and/or mouse 614, as well as the display controller 608, storage controller 624, network controller 606, sound controller 620, and I/O interface 612 is omitted herein for brevity, as these features are known.

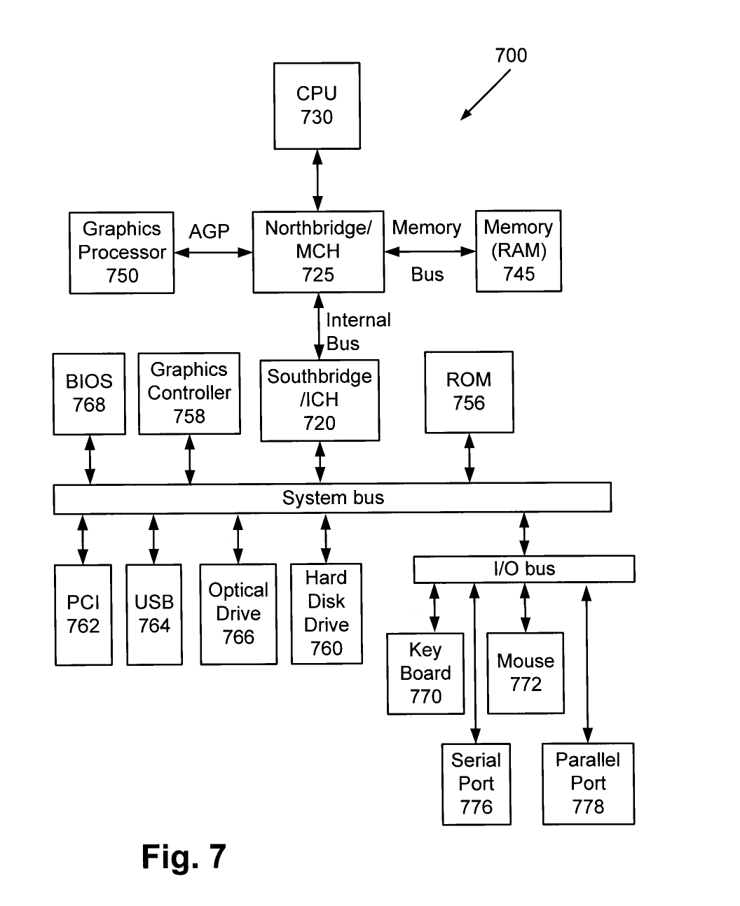

The exemplary circuit elements described in the context of the present disclosure can be replaced with other elements and structured differently than the examples provided herein. Moreover, processing circuitry configured to perform features described herein can be implemented in multiple circuit units (e.g., chips), or the features can be combined in processing circuitry on a single chipset, as shown in FIG. 7. The chipset of FIG. 7 can be implemented in conjunction with either electronic device 500 or computing device 600 described above with reference to FIGS. 5 and 6, respectively.

FIG. 7 is a block diagram of a data processing system, according to aspects of the disclosure described herein for performing menu navigation, as described herein. The data processing system is an example of a computer in which code or instructions implementing the processes of the illustrative embodiments can be located.

In FIG. 7, data processing system 700 employs an application architecture including a north bridge and memory controller hub (NB/MCH) 725 and a south bridge and input/output (I/O) controller hub (SB/ICH) 720. A CPU 730 is connected to NB/MCH 725. The NB/MCH 725 also connects to a memory 745, via a memory bus. The NB/MCH 725 also connects to a graphics processor 750, via an accelerated graphics port (AGP). The NB/MCH 725 also connects to the SB/ICH 720, via an internal bus (e.g., a unified media interface or a direct media interface). The CPU 730 can contain one or more processors and can be implemented using one or more heterogeneous processor systems.

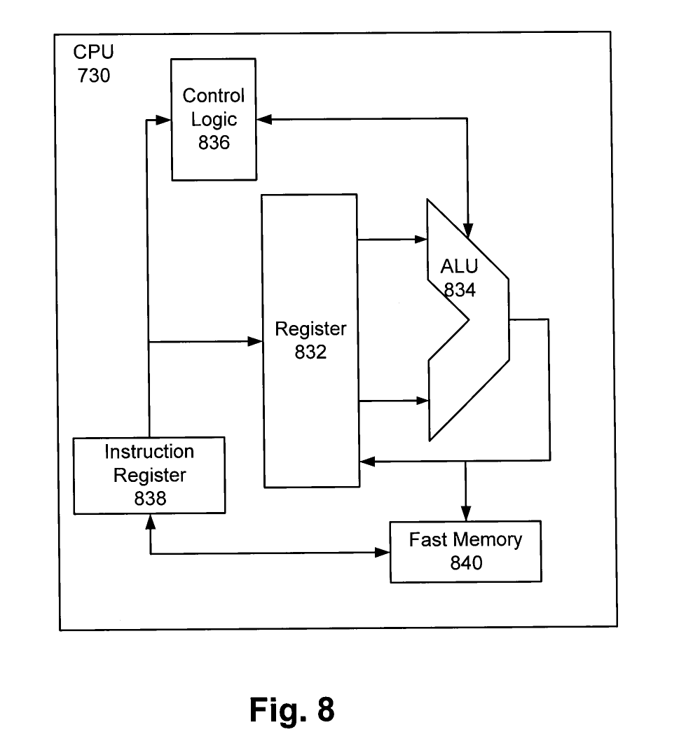

FIG. 8 is a block diagram illustrating one implementation of CPU 730. In one implementation, an instruction register 838 retrieves instructions from a fast memory 840. At least part of these instructions are fetched from the instruction register 838 by a control logic 836 and interpreted according to the instruction set architecture of the CPU 730. Part of the instructions can also be directed to a register 832. In one implementation the instructions are decoded according to a hardwired method, and in another implementation, the instructions are decoded according to a microprogram that translates instructions into sets of CPU configuration signals that are applied sequentially over multiple clock pulses.

After fetching and decoding the instructions, the instructions are executed using an arithmetic logic unit (ALU) 834 that loads values from the register 832 and performs logical and mathematical operations on the loaded values according to the instructions. The results from these operations can be fed back into the register 832 and/or stored in the fast memory 840.

According to aspects of the disclosure, the instruction set architecture of the CPU 730 can use a reduced instruction set computer (RISC), a complex instruction set computer (CISC), a vector processor architecture, or a very long instruction word (VLIW) architecture. Furthermore, the CPU 730 can be based on the Von Neuman model or the Harvard model. The CPU 730 can be a digital signal processor, an FPGA, an ASIC, a PLA, a PLD, or a CPLD. Further, the CPU 730 can be an x86 processor by Intel or by AMD; an ARM processor; a Power architecture processor by, e.g., IBM; a SPARC architecture processor by Sun Microsystems or by Oracle; or other known CPU architectures.

Referring back to FIG. 7, the data processing system 700 can include the SB/ICH 720 being coupled through a system bus to an I/O Bus. The system bus interconnects a read only memory (ROM) 756, universal serial bus (USB) port 764, a flash binary input/output system (BIOS) 768, and a graphics controller 758.

PCI/PCIe devices can also be coupled to SB/ICH 720 through a PCI bus 762. The PCI devices can include, for example, Ethernet adapters, add-in cards, and PC cards for notebook computers. A HDD 760 and CD-ROM 756 can use, for example, an integrated drive electronics (IDE) or serial advanced technology attachment (SATA) interface. In one implementation the I/O bus can include a super I/O (SIO) device.

The HDD 760 and an optical drive 766 can also be coupled to the SB/ICH 720 through the system bus. In one implementation, a keyboard 770, a mouse 772, a parallel port 778, and a serial port 776 can be connected to the system bus through the I/O bus. Other peripherals and devices can be connected to the SB/ICH 720 using a mass storage controller such as SATA or PATA, an Ethernet port, an ISA bus, a LPC bridge, SMBus, a DMA controller, and an Audio Codec.

The present disclosure is not limited to the specific circuit elements described herein, nor is the present disclosure limited to the specific sizing and classification of these elements. For example, the skilled artisan will appreciate that the processing circuitry described herein can be adapted based on changes to the battery sizing and the chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)).

The network can be a private network, such as a LAN or WAN, or can be a public network, such as the Internet. Input to the system can be received, via direct user input and received remotely, either in real-time or as a batch process. Additionally, some implementations can be performed on modules or hardware not identical to those described. Accordingly, other implementations are within the scope that can be claimed.

Distributed performance of the processing functions can be realized using grid computing or cloud computing. Many modalities of remote and distributed computing can be referred to under the umbrella of cloud computing, including software as a service, platform as a service, data as a service, and infrastructure as a service. Cloud computing generally refers to processing performed at centralized locations and accessible to multiple users who interact with the centralized processing locations through individual terminals.

The collaborative learning system 100 interconnects, via processing circuitry, associated programming with one or more hardware devices to provide an improved computerized collaborative learning system. The collaborative learning system 100 connects multiple computing applications together in the thinking phase 110, the pairing phase 120, and the sharing phase 130 for efficient navigation through one system.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative, but not limiting of the scope of the disclosure, including the claims. The disclosure, including any readily discernible variants of the teachings herein defines in part, the scope of the foregoing claim terminology, such that no inventive subject matter is dedicated to the public.

1. A method of collaborative learning, comprising:
receiving, via a graphical user interface (GUI), results from a preliminary test in a given subject matter for an individual;
saving, via a database, the results of the preliminary test;
determining, via a processor, a response speed, a response length, and a response quality for each test problem of the received results from the preliminary test;
saving, via the database, the determined response speed, the determined response length, and the determined response quality;
receiving, via the GUI, a first draft solution to an assigned problem from the individual working alone;
matching, via the processor, the individual with another similar individual based upon the received results from the preliminary test and the determined response speed, the determined response length, and the determined response quality;
receiving, via the GUI, a second draft solution to the assigned problem from the matched individuals working together;
submitting, via the GUI, an instructor response to the assigned problem to the matched individuals working together;
receiving, via the GUI, individual results of a posttest in the given subject matter from the matched individuals; and
saving, via the database, the individual results of the posttest for the matched individuals.

2. The method of claim 1, further comprising:
establishing a chat session, via the GUI, between the matched individuals working together from different locations.

3. The method of claim 1, wherein a content of the posttest includes content from the preliminary test.

4. The method of claim 1, further comprising:
matching, via the processor, the individual with another similar individual that has not previously worked with the individual as a pair.

5. The method of claim 4, further comprising:
saving, via the database, a history of the matching of each individual with another similar individual.

6. The method of claim 1, wherein the response speed includes an individual time of completion of the first draft solution.

7. The method of claim 6, wherein the response length includes a total number of characters of the first draft solution.

8. The method of claim 7, wherein the response quality includes a given score for the first draft solution based upon one or more of grammatical errors, misspellings, styling errors, and syntax errors.

9. The method of claim 8, further comprising:
saving, via the database, an average of the response speed, an average of the response length, and an average of the response quality for the completed first draft solution from a plurality of individuals.

10. The method of claim 1, wherein the matching further comprises:
obtaining a first set of users that have not been previously matched with the individual;
creating a first backup list from the first set of users;
obtaining a list of random users when the first set is empty;
obtaining a second set of users having a similar learning level as the individual;
forming a second backup list by adding the second set of users to one of the first backup list and the list of random users;
dropping non-duplicating names from the second backup list;
obtaining a third set of users having a similar response speed as the individual;
forming a third backup list by adding the third set of users to one of the second backup list, the first backup list, and the list of random users;
dropping non-duplicating names from the third backup list;
obtaining a fourth set of users having a similar response quality as the individual;
forming a fourth backup list by adding the fourth set of users to one of the third backup list, the second backup list, the first backup list, and the list of random users;
dropping non-duplicating names from the fourth backup list;
obtaining a fifth set of users having a similar response length as the individual;
forming a fifth backup list by adding the fifth set of users to one of the fourth backup list, the third backup list, the second backup list, the first backup list, and the list of random users;
dropping non-duplicating names from the fifth backup list;
generating a final list of users from results of the fifth backup list with no duplicating names; and
selecting a random user from the final list of users to match with the individual.

11. A collaborative learning system, comprising:
processing circuitry configured to receive results from a preliminary test in a given subject matter for an individual;
save the results of the preliminary test;
determine a response speed, a response length, and a response quality for each test problem of the received results from the preliminary test;
save the determined response speed, the determined response length, and the determined response quality;
receive a first draft solution to an assigned problem from the individual working alone;
match the individual with another similar individual based upon the received results from the preliminary test and the determined response speed, the determined response length, and the determined response quality;
receive a second draft solution to the assigned problem from the matched individuals working together;
submit an instructor response to the assigned problem to the matched individuals working together;
receive individual results of a posttest in the given subject matter from the matched individuals; and
save the individual results of the posttest for the matched individuals.

12. The collaborative learning system of claim 11, wherein the processing circuitry is further configured to establish a chat session between the matched individuals working together from different locations.

13. The collaborative learning system of claim 11, wherein a content of the posttest includes content from the preliminary test.

14. The collaborative learning system of claim 11, wherein the processing circuitry is further configured to match the individual with another similar individual that has not previously worked with the individual as a pair.

15. The collaborative learning system of claim 14, wherein the processing circuitry is further configured to save a history of matching each individual with another similar individual.

16. The collaborative learning system of claim 11, wherein the response speed includes an individual time of completion of the first draft solution.

17. The collaborative learning system of claim 16, wherein the response length includes a total number of characters of the first draft solution.

18. The collaborative learning system of claim 17, wherein the response quality includes a given score for the first draft solution based upon one or more of grammatical errors, misspellings, styling errors, and syntax errors.

19. The collaborative learning system of claim 18, wherein the processing circuitry is further configured to save an average of the response speed, an average of the response length, and an average of the response quality for the completed first draft solution from a plurality of individuals.

20. The collaborative learning system of claim 11, wherein the processing circuitry is further configured to
obtain a first set of users that have not been previously matched with the individual;
create a first backup list from the first set of users;
obtain a list of random users when the first set is empty;
obtain a second set of users having a similar learning level as the individual;
form a second backup list by adding the second set of users to one of the first backup list and the list of random users;
drop non-duplicating names from the second backup list;
obtain a third set of users having a similar response speed as the individual;
form a third backup list by adding the third set of users to one of the second backup list, the first backup list, and the list of random users;
drop non-duplicating names from the third backup list;
obtain a fourth set of users having a similar response quality as the individual;
form a fourth backup list by adding the fourth set of users to one of the third backup list, the second backup list, the first backup list, and the list of random users;
drop non-duplicating names from the fourth backup list;
obtain a fifth set of users having a similar response length as the individual;
form a fifth backup list by adding the fifth set of users to one of the fourth backup list, the third backup list, the second backup list, the first backup list, and the list of random users;
drop non-duplicating names from the fifth backup list;
generate a final list of users from results of the fifth backup list with no duplicating names; and
select a random user from the final list of users to match with the individual.
